(19) United States
(12) Patent Application Publication
(10) Pub. No.: US 2012/0222903 A1
(43) Pub. Date: Sep. 6, 2012

(54) PERSONAL TRAINER SCALE

(75) Inventors: Lawrence King, Westchester, IL (US); Jeffrey D. Koon, Lombard, IL (US); Martin Vespo, Chicago, IL (US); Ronni Emrich, Norridge, IL (US)

(73) Assignee: TAYLOR PRECISION PRODUCTS, INC., Oak Brook, IL (US)

(21) Appl. No.: 13/409,356

(22) Filed: Mar. 1, 2012

Related U.S. Application Data
(60) Provisional application No. 61/449,195, filed on Mar. 4, 2011.

(51) Int. Cl. G01G 19/40

(52) U.S. Cl. 177/1; 177/25.16

(57) ABSTRACT

A scale includes a weighing panel supported by a platform, a measurement module in communication with the weighing panel, a user interface supported by the platform and having at least one display and a user input, and a controller. The controller is in communication with the user interface and the measurement module. The controller is configured to: (i) receive a signal from the measurement module to determine a weight of a user, (ii) command the display to show the weight, (iii) receive an activity selection from the user input, and (iv) command the display to show the activity and a corresponding activity calorie estimate based on the weight of the user.

### CROSS-REFERENCE TO RELATED APPLICATIONS

This application claims the benefit of U.S. provisional Application No. 61/449,195 filed Mar. 4, 2011, the disclosure of which is incorporated in its entirety by reference herein.

### TECHNICAL FIELD

Various embodiments relate to a personal scale.

### BACKGROUND

Scales, such as weighing scales, are a measuring instrument used to determine the weight of a person, and are commonly found in homes and other locations for personal use. A user typically manually turns the scale on or stands on the scale to automatically power on the scale. The scale then uses a mechanical, electrical, or mechanoelectrical sensor, such as a mechanical spring or load cell, to measure the weight of the person on the scale and provide a gauge or display showing the measurement. Recently scales have begun incorporating additional features such as body fat measurements, water content, etc., to meet a demand created by health conscious consumers.

### SUMMARY

In an embodiment, a scale is provided with a platform, a weighing panel supported by the platform, a measurement module in communication with the weighing panel, and a user interface supported by the platform and having at least one display and a user input. The scale has a controller in communication with the user interface and the measurement module. The controller is configured to: (i) receive a signal from the measurement module to determine a weight of a user, (ii) command the display to show the weight, (iii) receive an activity selection from the user input, and (iv) command the display to show the activity and a corresponding activity calorie estimate based on the weight of the user.

In another embodiment, a method for controlling a scale is provided. A signal is received from a measurement module of the scale to determine a weight of a user. A display is commanded to show the weight. An activity selection is received from a user input. The display is commanded to show an activity type and a corresponding activity calorie estimate based on the weight.

In yet another embodiment, a computer readable medium having stored data representing instructions executable by a controller to control a scale is provided. The computer readable medium has instructions for receiving a signal from a measurement module of the scale to determine a weight of a user, instructions for commanding a display to show the weight, instructions for receiving an activity selection from a user input, and instructions for commanding the display to show an activity type and a corresponding activity calorie estimate based on the weight.

### BRIEF DESCRIPTION OF THE DRAWINGS

FIG. 1 illustrates a top plan view of a personal trainer scale according to an embodiment;

FIG. 2 illustrates a front view of the personal trainer scale of FIG. 1;

FIG. 3 illustrates a side view of the personal trainer scale of FIG. 1;

FIG. 4 illustrates a top plan view of a personal trainer scale according to another embodiment;

FIG. 5 illustrates a bottom plan view of the personal trainer scale of FIG. 4;

FIG. 6 illustrates a front view of the personal trainer scale of FIG. 4;

FIG. 7 illustrates a side view of the personal trainer scale of FIG. 4;

FIG. 8 illustrates a flow chart for user setup of a personal trainer scale according to an embodiment;

FIG. 9 illustrates a flow chart for clearing user memory for a personal trainer scale according to an embodiment;

FIG. 10 illustrates a flow chart for entering a weight only mode for a personal trainer scale according to an embodiment;

FIG. 11 illustrates a flow chart for operational use of a personal trainer scale according to an embodiment;

FIG. 12 illustrates a flow chart for setup of a personal trainer mode for a personal trainer scale according to an embodiment;

FIG. 13 illustrates a flow chart for display of a personal trainer mode for a personal trainer scale according to an embodiment;

FIG. 14 illustrates a flow chart for selecting additional activities for a personal trainer scale according to an embodiment;

FIG. 15 illustrates a flow chart for modifying an activity list for a personal trainer scale according to an embodiment; and

FIG. 16 illustrates memory locations for a personal trainer scale according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

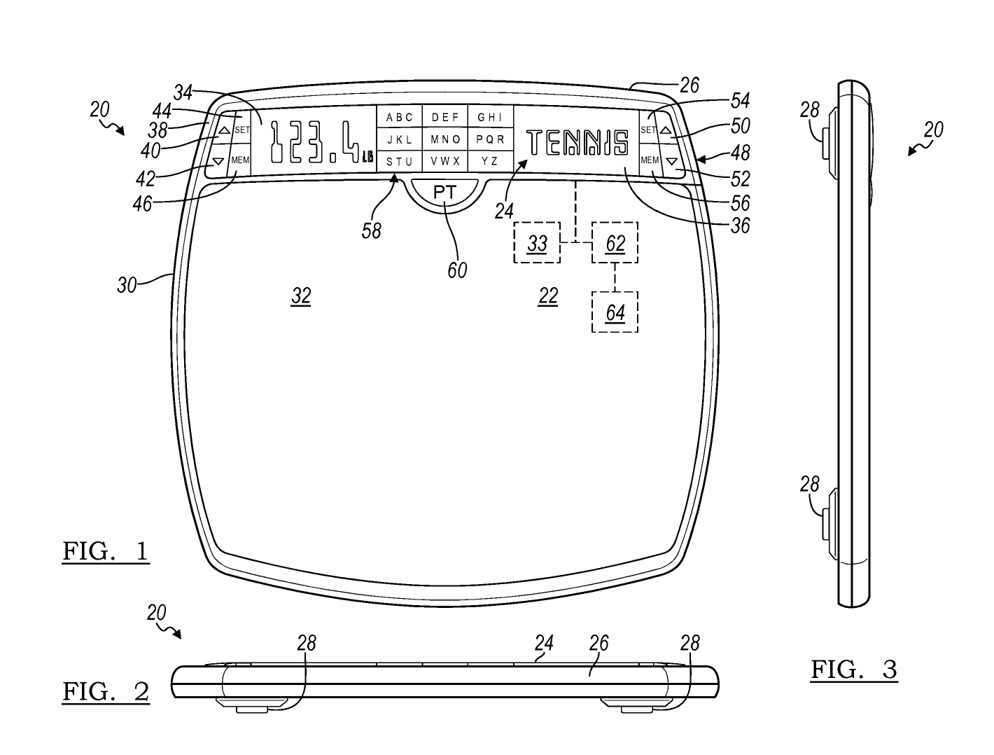

With reference to FIGS. 1-3, a personal trainer scale 20 is illustrated. The scale 20 has a platform 22 where a user may stand when using the scale 20. An integrated human interface 24 or user input extends along an upper edge region 26 of the platform 22. The platform 22 may be supported on an underlying surface by a series of feet 28 or the like. The feet 28 may have a rubber coating to prevent the scale 20 from slipping or moving on the underlying surface.

The platform 22 has a frame 30 and a weighing panel 32 supported by the platform 22. The panel 32 may be made from a plastic, glass or other material. In one embodiment, the panel 32 is made from transparent or frosted glass. The panel 32 may also have logos or other identifying characters for the scale 20. The panel 32 is connected or in communication with a measurement module 33, such as one or more sensors, which are configured to measure a weight of a user or object on the panel 32 and provide a signal for use by the scale 20. The sensor may be a strain gauge, load cell, or other sensor as is known in the art.

In one embodiment, the interface 24 has a first display screen 34 and a second display screen 36. The screens 34, 36 may be configured to display different sets of information to a user, as discussed below. The screens 34, 36 may be a liquid crystal display or other display as is known in the art. Of course, any number of screens is also contemplated for use with the scale 20. The first screen 34 has an associated control key pad 38. The key pad 38 may have up and down selector buttons 40, 42, a set button 44, and a memory button 46. Other buttons may also be associated with the key pad 38. The key pad 38 may have tactile buttons or be a touch screen and may be separate from or integrated into the screen 34.

The second screen 36 has an associated control key pad 48. The key pad 48 may have up and down selector buttons 50, 52, a set button 54, and a memory button 56. Other buttons may also be associated with the key pad 48. The key pad 48 may have tactile buttons or be a touch screen and may be separate from or integrated into the screen 36. In other embodiments a single key pad may be used with both screens 34, 36.

An alphanumeric or alphabetic-only key pad 58 may also be located on the interface 24. The alphanumeric key pad 58 is used with the personal trainer modes as discussed below. The alphanumeric key pad 58 is shown as being interposed between the screens 34, 36, although other positions are also contemplated. The key pad 58 may have tactile buttons or be a touch screen. The key pad 58 may also be separate from or integrated with the screens 34, 36. Alternatively, the key pad 58 may be incorporated into a remote control and communicate wirelessly with the scale 20.

A personal trainer button 60 may also be provided on the interface 24. In one embodiment, the button 60 is positioned inboard of the alphanumeric keypad 58 and interposed between the screens 34, 36. Of course, the button 60 may be otherwise positioned or incorporated into key pad 38, 48, or 58.

The screens 34, 36, the key pads 38, 48, 58, and the button 60 are in communication with a controller 62. The controller 62 is configured to receive signals from the weight sensors 33, receive user inputs to the scale 20, determine information to be shown to the user, and command the display to show the information to the user. Although the controller 62 is shown as a single module, any number of controllers may be used. The controller 62 may contain integrated memory or be connected to a separate memory module. The controller 62 is also connected to a power source 64 such as a replaceable battery or an external power supply to provide power to operate the scale 20.

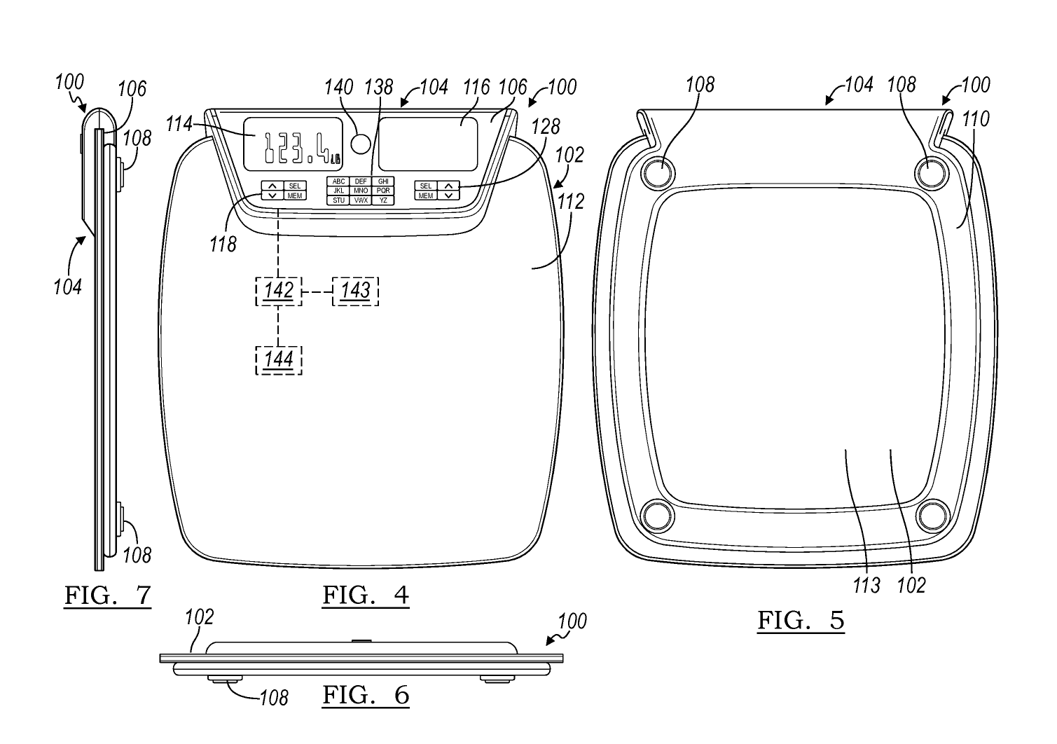

FIGS. 4-7 illustrate another embodiment of the scale 100. The scale 100 has a platform 102 where a user may stand when using the scale 100. An integrated human interface 104 for user input extends along an upper edge region 106 of the platform 102. The human interface 104 may be raised with respect to the platform 102. The platform 102 may be supported on an underlying surface by a series of feet 108 or the like. The feet 108 may have a rubber coating to prevent the scale 100 from slipping or moving on the underlying surface.

The platform 102 has a frame 110 and a weighing panel 112 supported by the platform 102. The panel 112 may be made from a plastic, glass or other material. In one embodiment, the panel 112 is made from transparent or frosted glass with a black coating on a rear surface 113 of the panel 112.

In one embodiment, the interface 104 has a first display screen 114 and a second display screen 116. The screens 114, 116 may be assigned to display different sets of information to a user, as discussed below. Of course, any number of screens is also contemplated for use with the scale 100. The first screen 114 has an associated control key pad 118. The key pad 118 may have up and down selector buttons, a set button, and a memory button. Other buttons may also be associated with the key pad 118. The key pad 118 may have tactile buttons or be a touch screen that may be separate or integrated into the screen 114.

The second screen 116 has an associated control key pad 128. The key pad 128 may have up and down selector buttons, a set button, and a memory button. Other buttons may also be associated with the key pad 128. The key pad 128 may have tactile buttons or be a touch screen that may be separate or integrated into the screen 116.

An alphanumeric or alphabetic-only key pad 138 may also be located on the interface 104. The alphanumeric key pad 138 is used with the personal trainer modes as discussed below. The alphanumeric key pad 138 is shown as being inboard of and interposed between the screens 114, 116, although other positions are also contemplated. The key pad 138 may have tactile buttons or be a touch screen. The key pad 138 may also be separate from or integrated with the screens 114, 116.

A personal trainer button 140 may also be provided on the interface 104. In one embodiment, the button 140 is interposed between the screens 114, 116 and is raised above the interface 104 surface. Of course, the button 140 may be otherwise positioned or incorporated into a key pad 118, 128, 138.

The screens 114, 116, the key pads 118, 128, 138, and the button 140 are in communication with a controller 142. The controller 142 allows for user inputs to the scale 100 and determines the display screen to be shown to the user. The controller 142 is configured to receive signals from the weight sensors in a measurement module 143, receive user inputs to the scale 20, determines information to be shown to the user, and command the display to show the information to the user. Although the controller 142 is shown as a single module, any number of controllers may be used. The controller 142 may contain integrated memory or be connected to a separate memory module. The controller 142 is also connected to a power source 144 such as a replaceable battery or an external power supply to provide power to operate the scale 100.

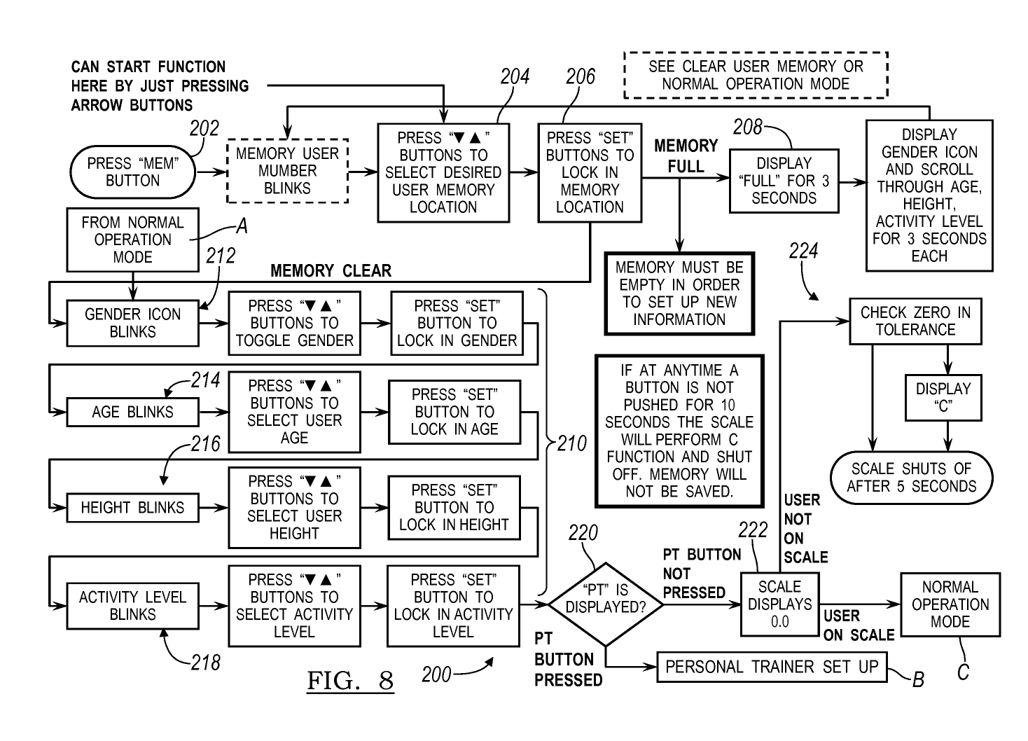

FIG. 8 illustrates a method of user setup of the scale 20 or a flow chart depicting a user setup of the scale 20 according to an embodiment. The flow chart may be used with scales 20, 100, or other embodiments of a scale. The use of FIGS. 8-15 is described with respect to the scale 20 shown in FIG. 1; however, this should not be viewed as limiting.

A user begins user setup 200 by pressing the MEM button 46 at 202, or alternatively can directly use the up and down keys 40, 42 to scroll to a memory location at 204. In one embodiment, the controller 62 of the scale 20 may store up to four user profiles. In other embodiments, any number of user profiles may be stored into a respective memory slot by the controller 62. The SET button 44 is used to select a memory location at 206. An embodiment of user profiles and memory slots or locations are described in greater detail below with respect to FIG. 16.

If the memory location selected is full, the controller 62 commands the screen, such as screen 34 to display “FULL” or another message indicating that the memory location is occupied at 208 and then proceeds to display the settings associated with the respective memory location on the screen.

If the memory location is empty or if the user prompts entry to this from block A, the controller 62 enters a series of setup prompts 210 for the user to select settings for the memory location.

The user may select their gender through process 212 as indicated by a gender icon on the screen 34 and use the up and down keys 40, 42 and the SET button 44 to make the appropriate selection.

The user may select their age through process 214 as indicated by a blinking age on the screen 34 and use the up and down keys 40, 42 and the SET button 44 to make the appropriate selection.

The user may select their height through process 216 as indicated by a blinking height on the screen 34 and use the up and down keys 40, 42 and the SET button 44 to make the appropriate selection.

The user may select their activity level as self-determined or chosen through process 218 as indicated by a blinking activity level on the screen 34. The user uses the up and down keys 40, 42 and the SET button 44 to make the appropriate activity level selection. An activity level may be a scale from 1-5 with 5 being a high activity level and 1 being a low or sedentary activity level. Of course, other activity level scales may also be used.

The order of the selection process 210 may differ from what is illustrated such that the processes 212, 214, 216, and 218 may be in any order. Additionally, any number of selection processes may be used with the setup prompt 210.

The user may then select to enter the personal trainer module at 220. If the user chooses to enter the personal trainer module, the controller goes to block B. If the user does not choose to enter the personal trainer module, the controller proceeds to 222 and displays a zero weight or other message on the screen 34. When a user steps onto the weighing panel 32, the controller 62 proceeds to block C as described below. If the user does not step onto the weighing panel 32, the controller 62 checks the tolerances of the scale 20, i.e. tares the scale 20, and then proceeds to shutdown after a designated time as shown through process 224.

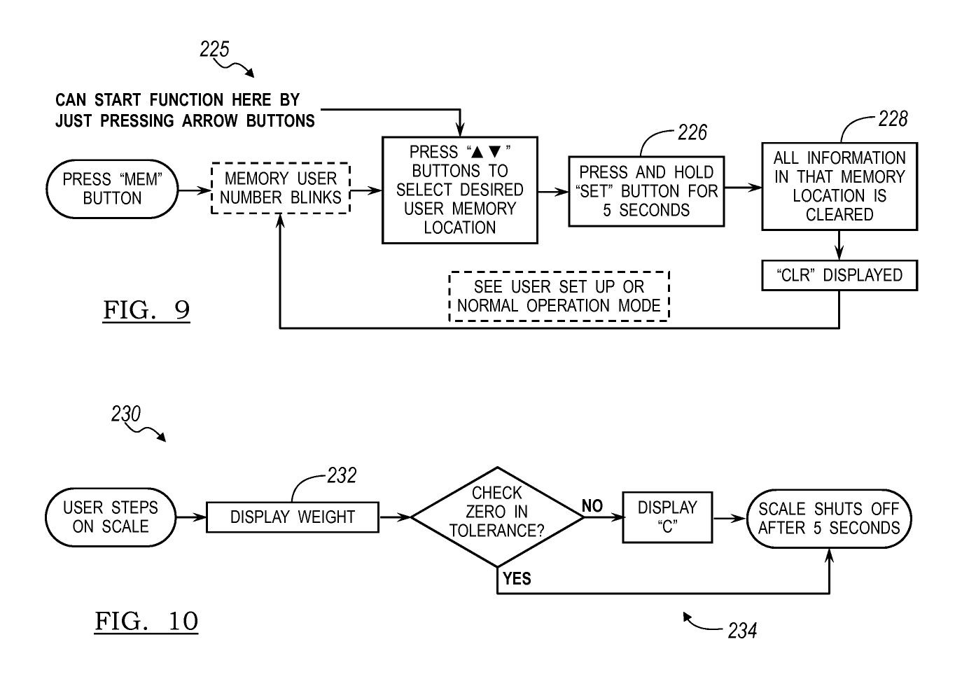

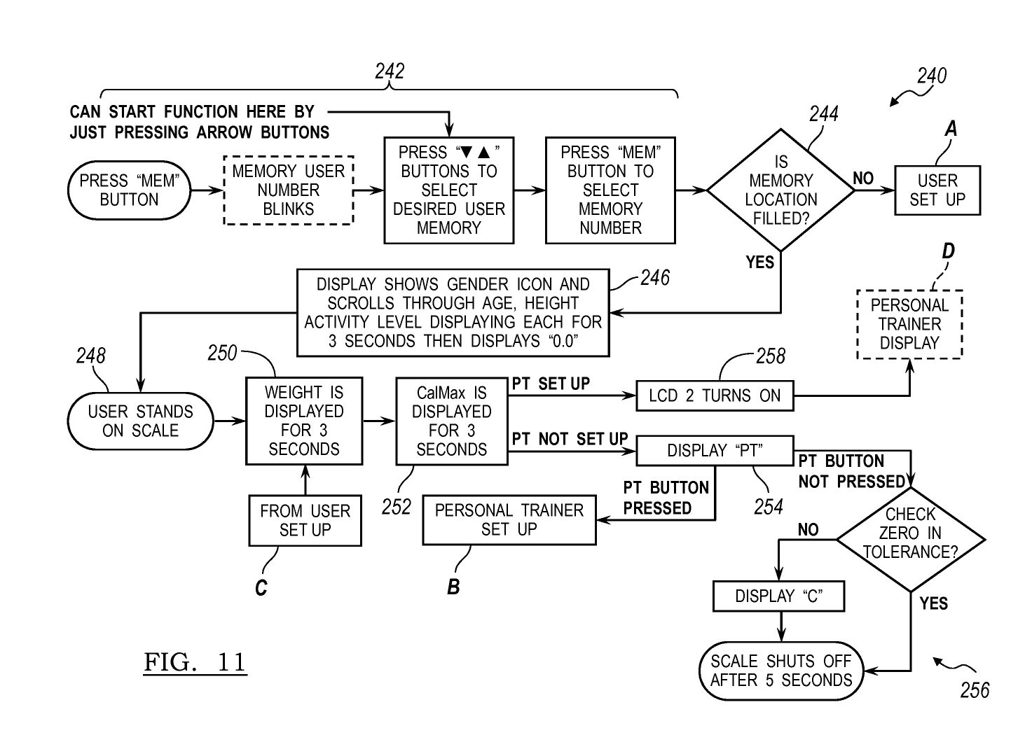

FIG. 9 illustrates a method of clearing the user memory 225. With a memory location being displayed on the screen 34, the SET button 44 is engaged for a designated time at 226 to send an input to the controller 62 to clear the settings from that memory location at 228. The controller 62 then commands the screen 34 to display a clear message for the user to indicate that the memory location is now open.

FIG. 10 illustrates a method of operation of the scale 20 for providing a weight measurement only 230. When the user steps onto the weighing panel 32, the controller 62 causes the scale 20 to turn on, weigh the user, and display the weight of the user on the screen 34 at 232. This process is not necessarily tied to a memory location. In another embodiment, the user is required to press a button to power on the scale 20 or wake the scale 20 up from a sleep mode before stepping onto the weighing panel 32. The controller 62 may also complete a tolerance check and enter a shutdown sequence after a designated time as shown at 234.

FIG. 11 illustrates a mode of operation of the scale 20 under normal conditions at 240 according to an embodiment. The user selects a memory location through process 242. If the selected memory location is empty the controller 62 proceeds to block A as shown in FIG. 8. If the memory location has associated settings, the controller 62 proceeds to display the settings on the screen 34 at 246. The controller 62 then commands the screen 34 to display a zero weight to indicate to the user that the scale 20 is ready for the next step.

The user may then stand on the weighing panel 32 to be weighed at 248 and the weight is displayed for a designated time at 250. Step 250 may also be reached from block C from FIG. 8. The controller 62 then uses the weight and the associated settings from the memory location to provide a calorie output at 252. The controller 62 may display a daily calorie intake to maintain the current weight of the user based on the information provided in the memory location and the use of a look up table or an algorithm to determine the estimated daily calorie intake. For example, the controller 62 may use a table, such as provided in “Calories burned in 30 minutes for people of three different weights,” in the Harvard Heart Letter, July 2004, along with a simple interpolation or extrapolation algorithm to estimate the daily calorie intake to maintain the weight of the user.

If the personal training module has not been setup, the controller 62 displays “PT” or another indicator on the screen 34 at 254. The user may then engage the personal training button 60 to enter the personal training setup at block B. If the user does not select the button 60, the controller 62 may complete a tolerance check and enter a shutdown sequence after a designated time as shown at 256.

If the personal training module has been setup by the user, the controller 62 proceeds to 258 and turns the second screen 36 on. The controller 62 then goes to block D.

The user may enter height, gender, age, and activity levels to a memory location and then stand on the scale 20 to get their weight and daily calorie intake to maintain current weight (CalMax reading). The user information as well as the weight and daily calorie intake information may be stored in the user's selected memory location as a user profile as described below with reference to FIG. 16.

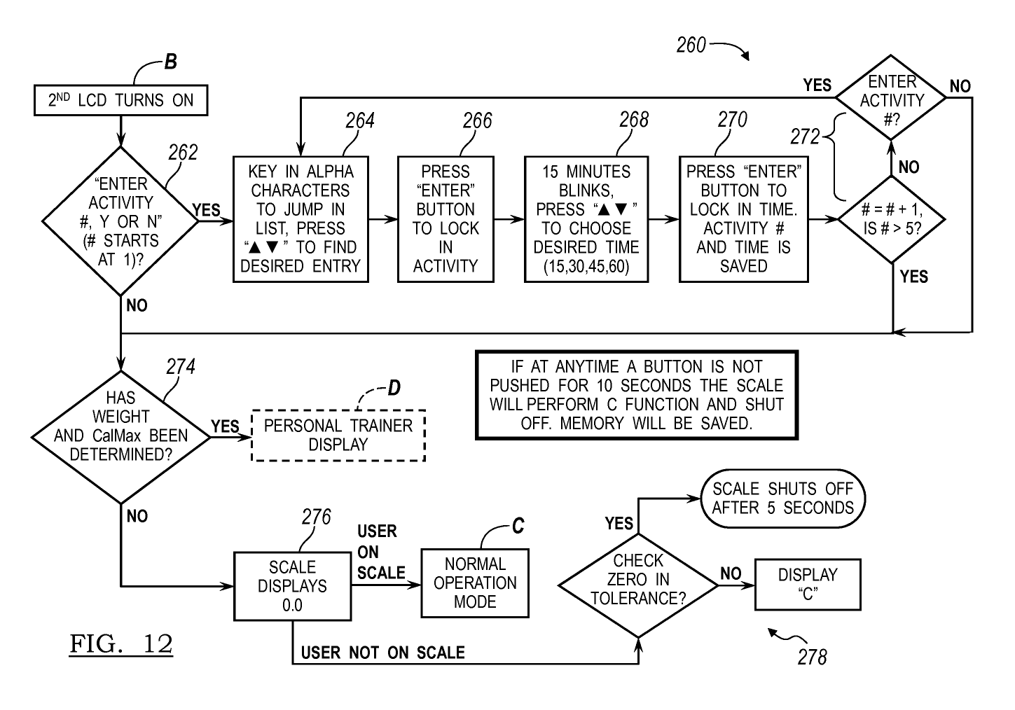

The personal trainer setup beginning at block B is illustrated in FIG. 12 at 260. The controller 62 has a number of stored activities with a memory associated with the controller 62. Activities may include, but are not limited to, walking at various paces, running at various paces, cycling, tennis, yoga, hockey, aerobics, weightlifting, gardening, hiking, dancing, football, soccer, kayaking, skiing, golf, and the like. Further examples of activities may be found in “Calories burned in 30 minutes for people of three different weights,” in the Harvard Heart Letter, July 2004, although the activities used by the scale 20 is not limited to those listed in the publication. The controller 62 may calculate the number of calories burned by performing the activity using the setting in the memory location and a look up table, an algorithm, a combination thereof, or other methods as are known in the art.

The activities are selected from the list of available activities in memory by using a combination of number keys and/or up and down arrows. Times may be selected and may be 15, 30, 45, and 60 minutes, for example. In one embodiment, the user can select and store up to 5 activities with designated times to recall from their memory location and they may also choose one that will not be saved for a one time use. Each memory location for a user may store up to five activities. Of course any number of activities may be stored and associated with a memory location. The one-time activity may be selected by a user to determine the calories burned for that activity without storing it or associating it with the memory location. Alternatively, the controller 62 for the scale 20 may select a random activity with a random time if the user wishes to be given an exercise option. In other embodiments, the user may be able to enter a user defined activity to supplement the database with activities not included.

The user may select a stored activity from their memory location or set an activity to the memory location at 262. To set an activity, the user selects an activity, such as using key pad 48, from the designated list of activities stored in memory associated with the controller 62 at 264 and 266. The user then uses the key pad 48 to select a duration for the activity, such as 15 minutes, 30 minutes, 45 minutes, 1 hour, or the like, at 268. The user then saves the selected activity and duration to an activity number in the associated memory location using inputs to key pad 48 at 272.

After an activity has been selected using the key pad or selected for a one time use, or alternatively if no activity has been selected, the controller 62 proceeds to 274, and determines if a weight and daily calorie intake has been calculated for the user. If a weight and daily calorie intake have been calculated for the user, the controller 62 proceeds to the personal trainer display at block D.

If the weight and daily calorie intake has not been calculated for the user, the controller 62 proceeds to a weighing operation at 276. If the user steps on the weighing panel 32 of the scale 20, the controller 62 goes to block C. If the user does not step on the scale 20, the controller 62 may complete a tolerance check and enter a shutdown sequence after a designated time as shown at 278.

If a button is not activated at any time during process 260 after a designated time, i.e. 10 seconds, the scale 20 may enter a shutdown sequence 278.

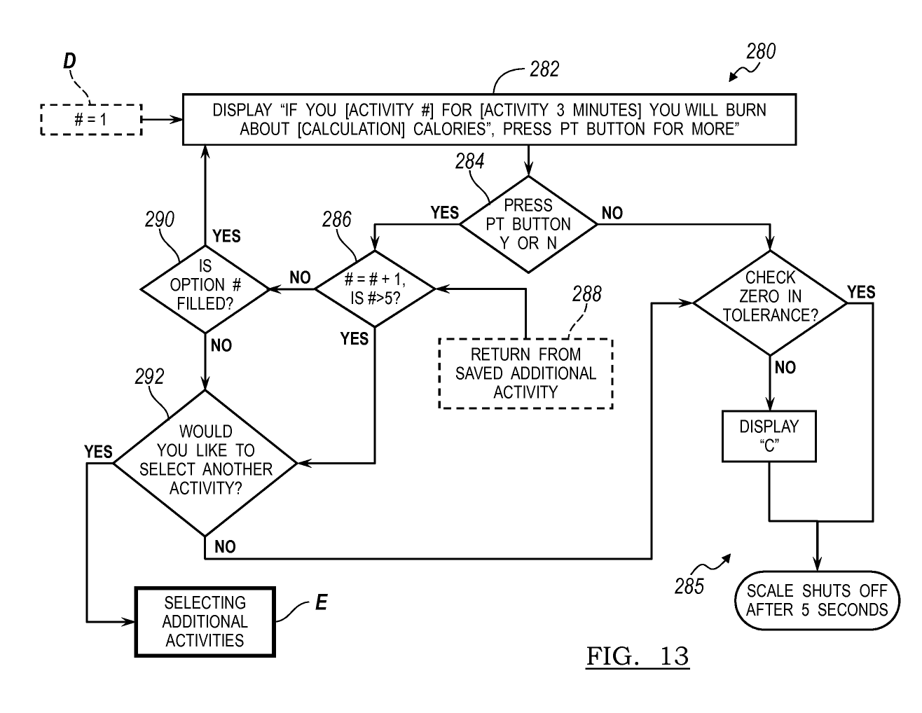

A process for a personal trainer module is illustrated in FIG. 13 as 280. The process 280 is entered at block D from another process, or alternatively may be entered at any time by a user by selecting the personal trainer button 60 and entering an activity number beginning at 284. The personal trainer module 280 may calculate information based on a database, an algorithm, or a combination thereof, and will inform the user of an estimate of the number of calories burned by doing a selected activity for a selected amount of time, or duration.

The controller 62 commands the display 36 to inform the user of the number of calories burned for an activity and associated duration based on the user profile information from the selected memory location at 282. The user may select the personal trainer button 60 for more information at 284. If the button 60 is not selected, the controller 62 may complete a tolerance check and enter a shutdown sequence after a designated time as shown at 285.

If the button 60 is selected, the controller 62 checks the activity number selected by the user, such as by using the key pad 48, 58, at 286 where it references the memory to find any saved activities for that memory location at 288. If the activity number selected has an associated activity and duration at 290, the controller 62 may proceed to 282 to display calories associated with the activity and duration for the user profile. If the activity number does not have associated information, the controller 62 proceeds from 290 to 292 and provides the user the option to select another activity through block E.

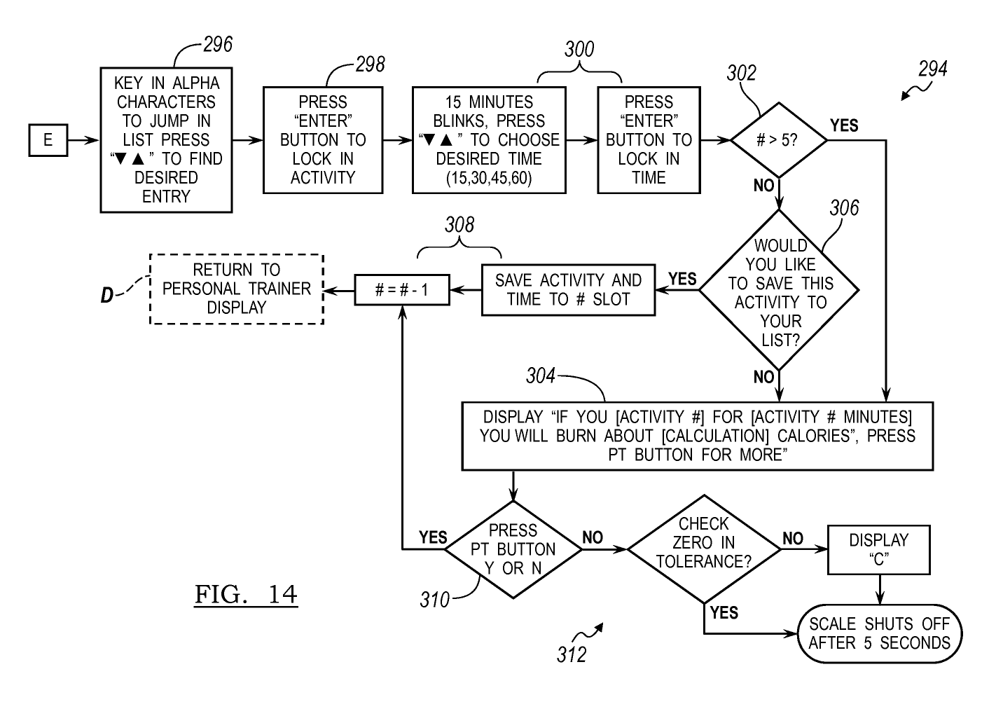

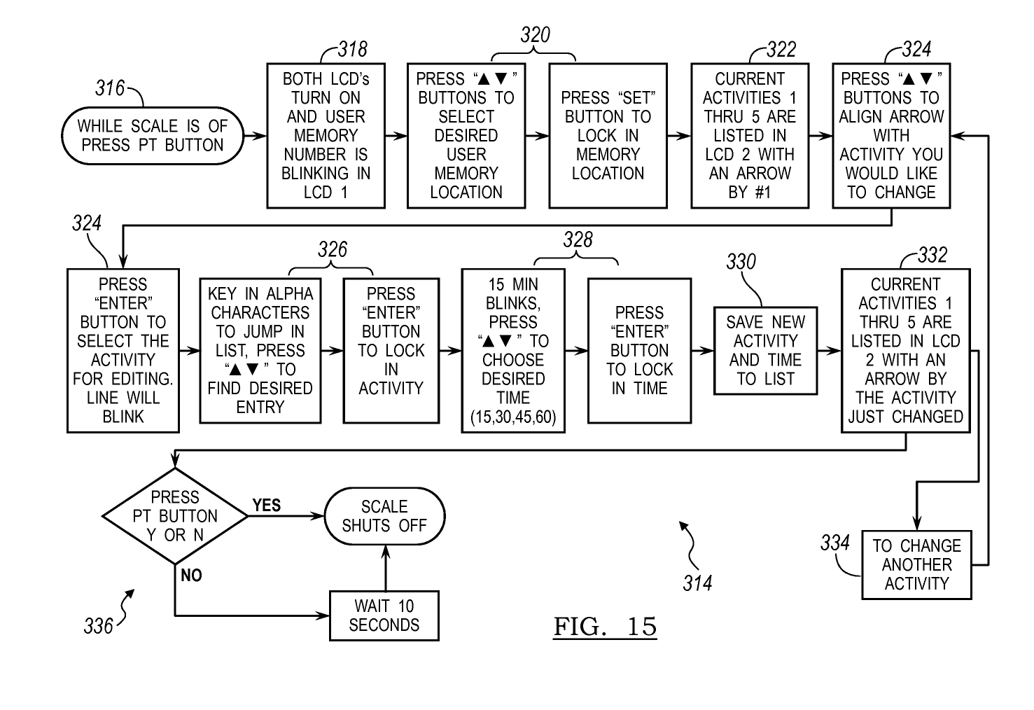

Process 294, as shown in FIG. 14, permits the user to select additional activities beginning at block E. The user can find an activity at 296 by typing in the name of the activity, such as by using the alphanumeric keypad 58 or using the up and down arrows 50, 52 on key pad 48. The user uses the key pad 48 to select the desired activity at 298 using key pad 48. The user then chooses a duration to be associated with the activity, and selects it using key pad 48 at 300. The user also chooses an activity number to be associated with the selected activity and duration and their memory location on the scale 20 at 302. If the number selected is greater than the number of activity numbers, or a one-time only activity option is selected using the key pad 48, 58, the controller 62 displays the calories burned for the selected activity and duration on screen 36 at 304.

If the activity number selected by the user is one of the activity numbers that may contain saved activity information, the controller 62 queries the user to determine if the user wishes to save the activity information at 306. If the user indicates no, the controller 62 proceeds to 304. If the user indicates that they wish to save the activity, the controller 62 saves the activity to the indicated number slot in memory and associated with the user memory location at 308. The controller 62 may then return to block D.

From step 304, if the user selects the personal training button 60 at 310, the process goes to step 308. If the button 60 is not selected at 310, the controller 62 enters a tolerance check and a shutdown sequence after a designated time as shown at 312.

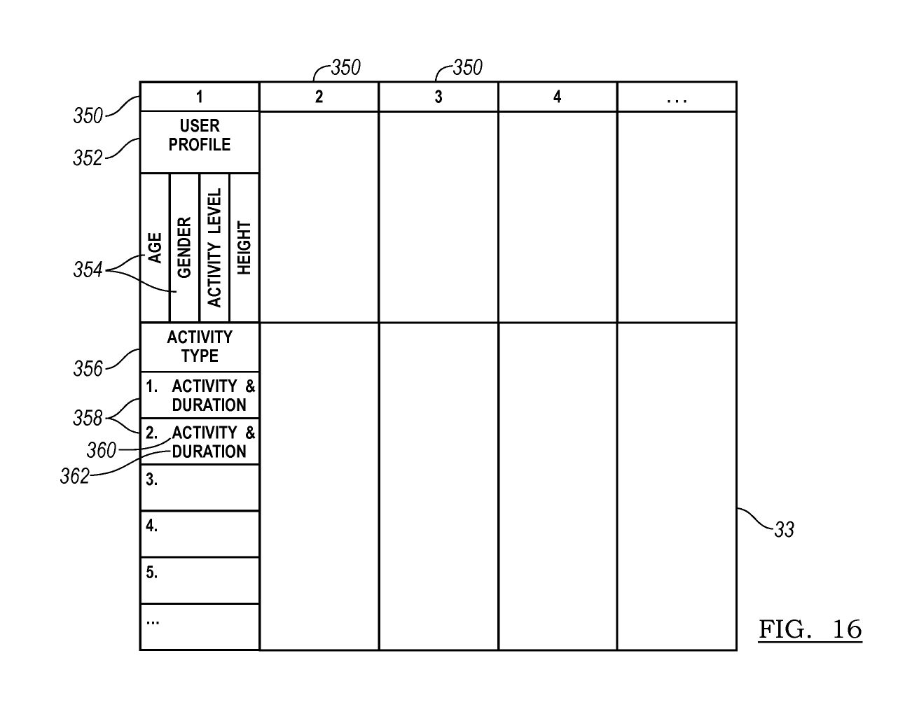

A process for modifying the activity list is shown at 314 in FIG. 15. When the scale 20 is shutdown, off, or in a sleep mode, the user begins by pressing the personal training button 60 at 316. The controller 62 turns both screens 34, 36 on at 318. The user then selects the appropriate memory location containing the user profile at 320, such as by using key pad 38. The controller 62 displays the activities stored in their respective slots on the second screen 36 at 322. The user selects which activity they would like to change at 324, such as by using key pad 48. The user uses the key pad 48 or 58 to select the desired activity at 326. The user then selects a duration using key pad 48 at 328. The controller 62 saves the selected activity and duration to the activity number for the memory location at 330.

The controller 62 displays the activities stored in their respective slots on the second screen 36 at 332. The user may select another activity to change at 334. If the user is finished making changes and presses the button 60, or if no user inputs are sent to the controller 62 for a designated time, the controller 62 shuts down or enter a sleep mode for the scale 20 at 336.

FIG. 16 illustrates an example of a memory storage hierarchy for use with memory 33. Several memory locations 350 are provided in the memory 33. Each memory location 350 contains user profile 352 information. Within the user profile 352, user information 354 such as age, gender, height, and activity level may be saved. Other information, such as a previous weight measurement, body fat, etc. may also be stored in the user information 354.

Activity type information 356 may also be stored for each memory location 350 and tied to a user profile 352. Multiple activity types 358 may be stored, and each type 358 includes information regarding the activity 360 itself and the duration 362 of the activity.

The controller 62 uses the user information 354 and selected other information from a memory location 350 with other data stored in the memory 33, such as a database of activities and associated calorie information, to calculate calorie information for each individual user based on their user information 354, type of activity 360, and duration 362 of the activity.

The flowcharts represent control logic which may be implemented by the controller 62, or another controller within the scale 20, using hardware, software, or a combination of hardware and software. For example, the various functions may be performed using a programmed microprocessor. The control logic may be implemented using any of a number of known programming or processing techniques or strategies and is not limited to the order or sequence illustrated. For instance, interrupt or event-driven processing, sequential strategy, parallel processing, multitasking, or multi-threaded systems and methods may be used.

The methods and algorithms are independent of any particular programming language, operating system processor, or circuitry used to develop and/or implement the control logic illustrated. Likewise, depending upon the particular programming language and processing strategy, various functions may be performed in the sequence illustrated at substantially the same time or in a different sequence. The illustrated functions may be modified or in some cases omitted without departing from the spirit or scope of the present invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments that are not explicitly illustrated or described.

What is claimed is:

1. A scale comprising:
a platform;
a weighing panel supported by the platform;
a measurement module in communication with the weighing panel;
a user interface supported by the platform and having at least one display and a user input; and
a controller in communication with the user interface and the measurement module, the controller configured to: (i) receive a signal from the measurement module to determine a weight of a user, (ii) command the display to show the weight, (iii) receive an activity selection from the user input, and (iv) command the display to show the activity and a corresponding activity calorie estimate based on the weight of the user.

2. The scale of claim 1 wherein the at least one display comprises a first display and a second display.

3. The scale of claim 2 wherein the controller is configured to command the first display to show the weight, and command the second display to show the activity and corresponding activity calorie estimate.

4. The scale of claim 2 wherein the user input comprises a first key pad associated with the first display and a second key pad associated with the second display.

5. The scale of claim 1 wherein the user input comprises an alphanumeric keypad.

6. The scale of claim 1 wherein the controller is configured to command the display to show a daily calorie estimate based on a user profile.

7. The scale of claim 1 wherein the user input further comprises an activity input button.

8. A method for controlling a scale, comprising:
receiving a signal from a measurement module of the scale to determine a weight of a user;
commanding at least one display to show the weight;
receiving an activity selection from a user input; and
commanding the at least one display to show an activity type and a corresponding activity calorie estimate based on the weight.

9. The method of claim 8 further comprising storing a user profile.

10. The method of claim 9 wherein the user profile includes at least one of an age, a height, a gender, and an activity level.

11. The method of claim 9 wherein the at least one display comprises a first display and a second display.

12. The method of claim 11 further comprising:
commanding the first display to show a daily calorie estimate based on the weight and the user profile; and
commanding the second display to show a daily calorie estimate based on the weight and the user profile.

13. The method of claim 12 wherein the daily calorie estimate is determined using one of an algorithm and a look-up table.

14. The method of claim 9 further comprising storing a series of designated activity types.

15. The method of claim 14 further comprising receiving one of the activity types from the series of activity types from a user selection to the scale.

16. The method of claim 14 wherein each activity type includes an activity and a duration.

17. The method of claim 16 further comprising receiving a duration from a user selection to the scale.

18. The method of claim 16 wherein the activity calorie estimate is based on the weight, the activity type, and the user profile.

19. The method of claim 18 wherein the activity calorie estimate is determined using one of an algorithm and a look-up table.

20. A computer readable medium having stored data representing instructions executable by a controller to control a scale, comprising:
instructions for receiving a signal from a measurement module of the scale to determine a weight of a user;
instructions for commanding at least one display to show the weight;
instructions for receiving an activity selection from a user input; and
instructions for commanding the at least one display to show an activity type and a corresponding activity calorie estimate based on the weight.
